(19) United States
(12) Patent Application Publication
(10) Pub. No.: US 2024/0352209 A1
(43) Pub. Date: Oct. 24, 2024

(54) BIODEGRADABLE FOAM COMPOSITION

(71) Applicant: Sung Yull LEE, Busan (KR)

(72) Inventor: Sung Yull LEE, Busan (KR)

(21) Appl. No.: 18/701,135

(22) PCT Filed: May 9, 2022
(86) PCT No.: PCT/KR2022/006543

§ 371 Date: Jun. 3, 2024

(30) Foreign Application Priority Data
May 10, 2021 (KR) 10-2021-0060020

(51) Int. Cl. C08J 9/00; C08J 9/06; C08J 9/12

(52) U.S. Cl. CPC C08J 9/0023; C08J 9/06; C08J 9/12; C08J 2309/00; C08J 2309/06; C08J 2323/04; C08J 2323/16; C08J 2367/03; C08J 2415/00

(57) ABSTRACT

Provided is a biodegradable foam composition that uses biodegradable materials instead of some rubber components to achieve high biodegradation efficiency. The biodegradable foam composition includes a polyalkylene adipate terephthalate (PAAT) resin, a peroxide crosslinking agent, a polymer capable of being crosslinked by the peroxide crosslinking agent, and a foaming agent.

### TECHNICAL FIELD

The present invention relates to a biodegradable foam composition, and more specifically to a biodegradable foam composition that uses biodegradable materials instead of some foam components to achieve high biodegradation efficiency.

### BACKGROUND ART

Various types of foams are used in shoe midsoles, insulation materials, and packaging materials. However, more research needs to be conducted on methods for methods for imparting biodegradability to foams that adversely affect the global environment.

Specifically, methods for imparting biodegradability to foams were developed in which some components of conventional foam compositions are replaced with biodegradable materials, for example, a low-density polylactic acid (Korean Patent No. 10-1650712) and an amorphous polylactic acid resin (Korean Patent No. 10-1393811).

According to these methods, however, since the polylactic acid as a main component is suitable for the manufacture of foams with high hardness, the use of the foams is greatly limited. Further, the biodegradability of the foams fails to reach a satisfactory level.

Thus, there is a need to develop a technology for easily foaming a highly biodegradable foam composition.

### DETAILED DESCRIPTION OF THE INVENTION

### Problems to be Solved by the Invention

The present invention has been made in an effort to solve the above-described problems and is intended to provide a biodegradable foam composition that uses biodegradable materials instead of some foam components to achieve high biodegradation efficiency.

### Means for Solving the Problems

An aspect of the present invention provides a biodegradable foam composition including a polyalkylene adipate terephthalate (PAAT) resin, a peroxide crosslinking agent, a polymer capable of being crosslinked by the peroxide crosslinking agent, and a foaming agent.

In one embodiment, the polyalkylene adipate terephthalate (PAAT) resin may be a polyethylene adipate terephthalate, polybutylene adipate terephthalate or polytrimethylene adipate terephthalate resin.

In one embodiment, the crosslinkable polymer may be a crosslinkable plastic or rubber.

In one embodiment, the crosslinkable plastic may be an ethylene homopolymer or copolymer.

In one embodiment, the crosslinkable rubber may be selected from the group consisting of natural rubber (NR), styrene butadiene rubber (SBR), butadiene rubber (BR), styrene butadiene styrene (SBS) rubber, nitrile-butadiene rubber (NBR), ethylene-propylene rubber (EPM), ethylene-propylene diene monomer (EPDM) rubber, silicone rubber, styrene block copolymer (SBC), 1,2-polybutadiene (1,2-PB), chlorinated polyethylene (CPE), ethylene vinyl acetate rubber (EVM), thermoplastic polyurethane (TPU) elastomer, and mixtures thereof.

In one embodiment, the polyalkylene adipate terephthalate resin and the crosslinkable polymer may be present in a weight ratio of 95:5 to 30:70.

In one embodiment, the biodegradable foam composition may further include a compatibilizer.

In one embodiment, the compatibilizer may be a maleic anhydride (MAH)-grafted rubber.

In one embodiment, the peroxide crosslinking agent may be selected from the group consisting of t-butyl peroxyisopropyl carbonate, t-butyl peroxylaurylate, t-butyl peroxyacetate, di-t-butyl peroxyphthalate, t-dibutyl peroxymaleate, cyclohexanone peroxide, t-butyl cumyl peroxide, t-butyl hydroperoxide, t-butyl peroxybenzoate, dicumyl peroxide, 1,3-bis(t-butylperoxyisopropyl)benzene, methyl ethyl ketone peroxide, 2,5-dimethyl-2,5-di(benzoyloxy)hexane, 2,5-dimethyl-2,5-di(t-butylperoxy)hexane, di-t-butyl peroxide, 2,5-dimethyl-2,5-(t-butylperoxy)-3-hexane, n-butyl-4,4-bis(t-butylperoxy)valerate, α,α′-bis(t-butylperoxy)diisopropylbenzene, and mixtures thereof.

In one embodiment, the foaming agent may be a physical or chemical foaming agent.

### Effects of the Invention

The presence of the rubber and/or plastic capable of being crosslinked by the peroxide and the polyalkylene adipate terephthalate (PAAT) makes the biodegradable foam composition of the present invention highly processable and moldable. In addition, the biodegradable foam composition of the present invention can be used to provide a foam that is highly biodegradable in nature and exhibits high strength and durability.

### MODE FOR CARRYING OUT THE INVENTION

Preferred embodiments of the present invention will now be described in detail. In the description of the present invention, detailed explanations of related art are omitted when it is deemed that they may unnecessarily obscure the essence of the present invention. Throughout the specification, the singular forms “a”, “an” and “the” are intended to include the plural forms as well, unless the context clearly indicates otherwise. In the present invention, it is to be understood that the terms such as “including” or “having,” etc., are intended to indicate the existence of the features, numbers, steps, operations, components, parts, or combinations thereof disclosed in the specification, and are not intended to preclude the possibility that one or more other features, numbers, steps, operations, components, parts, or combinations thereof may exist or may be added. Respective steps of the methods described herein may be performed in a different order than that which is explicitly described. In other words, the respective steps may be performed in the same order as described, substantially simultaneously, or in a reverse order.

The present invention is not limited to the illustrated embodiments and may be embodied in various different forms. Rather, the disclosed embodiments are provided so that this disclosure will be thorough and complete, and will fully convey the scope of the invention to those skilled in the art. In the drawings, the dimensions, such as widths and thicknesses, of elements may be exaggerated for clarity. The drawings are explained from an observer's point of view. It will be understood that when an element is referred to as being “on” another element, it can be directly on the other element, or one or more intervening elements may also be present therebetween. It will be understood by those skilled in the art that various changes in form and details may be made therein without departing from the spirit and scope of the invention as defined by the appended claims. The same reference numerals represent substantially the same elements throughout the drawings.

As used herein, the term “and/or” encompasses both combinations of the plurality of related items disclosed and any item from among the plurality of related items disclosed. In the present specification, the description “A or B” means “A”, “B”, or “A and B.”

A biodegradable foam composition of the present invention includes a polyalkylene adipate terephthalate (PAAT) resin, a peroxide crosslinking agent, a polymer capable of being crosslinked by the peroxide crosslinking agent, and a foaming agent.

The crosslinkable polymer may be a crosslinkable plastic or rubber. The crosslinkable rubber may be selected from the group consisting of natural rubber (NR), styrene butadiene rubber (SBR), butadiene rubber (BR), styrene butadiene styrene (SBS) rubber, nitrile-butadiene rubber (NBR), ethylene-propylene rubber (EPM), ethylene-propylene diene monomer (EPDM) rubber, silicone rubber, styrene block copolymer (SBC), 1,2-polybutadiene (1,2-PB), chlorinated polyethylene (CPE), ethylene vinyl acetate rubber (EVM), thermoplastic polyurethane (TPU) elastomer, and mixtures thereof. When the crosslinkable rubber is mixed with the high-hardness PAAT resin, the hardness of the mixture can be adjusted to a value required for a rubber due to the inherently low hardness of the crosslinkable rubber. Particularly, the crosslinkable rubber can be co-crosslinked with the PAAT resin when crosslinked by the peroxide.

The rubbers listed above are those that can be crosslinked by peroxides and are thus suitable for use in the biodegradable foam composition of the present invention. When considering both versatility and price, the crosslinkable rubber may be, for example, selected from styrene butadiene rubber (SBR), butadiene rubber (BR), styrene butadiene styrene (SBS) rubber, and ethylene propylene diene monomer (EPDM) rubber.

Styrene butadiene rubber (SBR) is composed of a copolymer of styrene and butadiene and is produced by emulsion polymerization or solution polymerization. The physical properties of SBR can be determined by varying the contents of styrene and butadiene, enabling the production of SBR with various physical properties. The biodegradable foam composition of the present invention may use SBR whose styrene content is in the range of 20 to 30% by weight. Within this range, the SBR may have appropriate physical properties. Meanwhile, outside this range, the physical properties of the biodegradable foam composition using the SBR may deteriorate.

Butadiene rubber (BR) is produced by polymerization of butadiene and its physical properties may vary depending on the content of the cis-component. Here, it is preferable that the biodegradable foam composition uses a high-cis butadiene rubber with good wear resistance. It is more preferable that the content of the cis-component in the high-cis butadiene rubber is at least 90%. If the content of the cis-component is lower than 90%, the high-cis butadiene rubber is highly elastic but may exhibit poor wear resistance. Thus, the biodegradable foam composition may also use a mixture of two or more types of butadiene rubbers to adjust the content of the cis-component to an appropriate level.

Styrene butadiene styrene (SBS) rubber refers to a block copolymer that is produced by polymerization of styrene and butadiene in an organic solvent. SBS rubber is a thermoplastic elastomer that has high elasticity even without vulcanization and good recoverability from deformation on account of its molecular structure. SBS is widely used in various applications such as asphalt modifiers, adhesives, and pressure-sensitive adhesives and its use is currently increasing in products such as shoe soles and tires where good wear resistance is required. Currently commercially available SBS products have various physical properties depending on the content of styrene, the presence or absence of oil, and viscosity. It is preferable that the biodegradable foam composition of the present invention uses a SBS product with good wear resistance, specifically an oil-free SBS product whose styrene content is in the range of 20 to 23% by weight. Within this range, the SBS product has an appropriate viscosity and elasticity and is suitable for use as a rubber. Meanwhile, outside this range, the SBS product cannot be produced by polymerization or has high hardness, making it difficult to use as a rubber.

Ethylene propylene diene monomer (EPDM) rubber is produced by polymerization of ethylene and propylene and is known to have good durability against sunlight, especially ultraviolet light and ozone. EPDM rubber is also known to have good storage stability, cold resistance, heat resistance, and solvent resistance. Due to these advantages, EPDM rubber is used in many applications, such as road paving materials, flooring materials, building interior and exterior materials, automobile interior and exterior materials, and heat-resistant materials. EPDM rubber is mainly produced by copolymerizing a diene with an ethylene propylene monomer (EPM), followed by vulcanization. EPDM rubber products with different diene contents are commercially available. It is preferable that the biodegradable foam composition of the present invention uses a highly durable and wear-resistant EPDM rubber product whose diene content is 3 to 6% by weight.

The chemical structure of the polyalkylene adipate terephthalate may vary depending on the type of the alkylene linkage. The polyalkylene adipate terephthalate (PAAT) is preferably polyethylene adipate terephthalate (PEAT), butylene adipate terephthalate (PBAT) or polytrimethylene adipate terephthalate (PTAT). The polybutylene adipate terephthalate (PBAT) is particularly preferred because it is commercially produced and sold and has excellent physical properties.

The polybutylene adipate terephthalate (PBAT) resin is biodegradable and is a type of copolymer that is also called poly(butylene adipate-co-terephthalate). The PBAT is a type of polymer that has the characteristics of currently available PBA and PBT.

The PBAT may be represented by Formula 1:

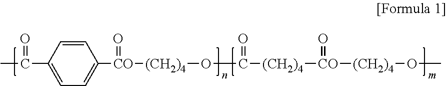

The PBAT has high elasticity and toughness and its characteristics can be modified when mixed with other polymers.

The PBAT is known to have high toughness and good high temperature resistance due to the flexible aliphatic chains and the rigid aromatic chains contained therein. In addition, the presence of the ester bonds explains the biodegradability of the PBAT, indicating that the PBAT can be used as a reinforcing material for various polymer resins and can impart biodegradability to polymer resins. In conclusion, the PBAT is considered the most active material that can be used to investigate biodegradable plastics or the best biodegradable material that can be introduced into the market.

The PBAT resin can be synthesized by general methods known in the art, a method including the following steps:

First, 1,4-butanediol is allowed to react with terephthalic acid at 240° C. to 260° C. for 2 to 5 hours. To the reaction mixture is added adipic acid to initiate the esterification reaction. The esterification reaction is performed at 240° C. to 260° C. for 2 to 5 hours. Finally, a catalyst and a stabilizer are added to perform the polycondensation reaction. The polycondensation reaction is allowed to proceed at 240° C. to 260° C. for 3 to 5 hours. The molar ratio of the 1,4-butanediol to the terephthalic acid is 3-5:1.

The proportion (T %) of the butylene terephthalate units in the PBAT resin is from 35% to 65% by weight. If the T % is less than 35% by weight, the obtained product is excessively soft, making its use unfavorable. Meanwhile, if the T % exceeds 65% by weight, the product is too hard and is thus difficult to use.

The terephthalate and adipate moieties in the copolymer PBAT are preferably in a molar ratio of 6:4 to 5:5. n and m in Formula 1 may be, for example, 0.56 and 0.44, respectively.

The crosslinkable polymer and the PAAT are present in a weight ratio of 95:5 to 30:70, preferably 73:27 to 35:65, more preferably 70:30 to 40:60. If the content of the PAAT is lower than the lower limit, the biodegradability of the composition may be insignificant. Meanwhile, if the content of the PAAT exceeds the upper limit, the hardness of the composition may be increase, losing its function as a foam.

The crosslinkable polymer may be a crosslinkable plastic or rubber.

Specifically, the crosslinkable plastic may be, for example, an ethylene homopolymer or copolymer.

Ethylene may be polymerized to polyethylene. Ethylene is homopolymerized to an ethylene homopolymer. Ethylene is mixed and copolymerized with a different type of monomer to produce an ethylene copolymer. The ethylene homopolymer or copolymer can be co-crosslinked with the PAAT. This co-crosslinking enables the manufacture of a biodegradable foam whose physical properties are controllable.

The peroxide crosslinking agent is used for appropriate co-crosslinking of the PAAT with the crosslinkable rubber. An existing PAAT resin is incompatible with a non-degradable resin, limiting its use in a mixture with the non-degradable resin. In contrast, the PAAT can be used in admixture with the crosslinkable rubber in the biodegradable foam composition of the present invention because the use of the peroxide crosslinking agent enables co-crosslinking between the PAAT and the crosslinkable rubber, allowing the biodegradable rubber to have desired physical properties. That is, the co-crosslinking between the PAAT and the crosslinkable rubber allows the rubber to have physical properties sufficient for practical use.

The peroxide crosslinking agent is selected from the group consisting of, but not limited to, t-butyl peroxyisopropyl carbonate, t-butyl peroxylaurylate, t-butyl peroxyacetate, di-t-butyl peroxyphthalate, t-dibutyl peroxymaleate, cyclohexanone peroxide, t-butyl cumyl peroxide, t-butyl hydroperoxide, t-butyl peroxybenzoate, dicumyl peroxide, 1,3-bis(t-butylperoxyisopropyl)benzene, methyl ethyl ketone peroxide, 2,5-dimethyl-2,5-di(benzoyloxy)hexane, 2,5-dimethyl-2,5-di(t-butylperoxy)hexane, di-t-butyl peroxide, 2,5-dimethyl-2,5-(t-butylperoxy)-3-hexane, n-butyl-4,4-bis(t-butylperoxy)valerate, α,α′-bis(t-butylperoxy)diisopropylbenzene, and mixtures thereof.

For example, an isobutylene-containing rubber such as isobutylene isoprene rubber (IIR) is unsuitable for use as the crosslinkable rubber in the present invention because it is not crosslinked by the peroxide crosslinking agent.

The content of the peroxide crosslinking agent may be 0.01 to 5 parts by weight, preferably 0.1 to 3 parts by weight, more preferably 0.5 to 2 parts by weight, based on the sum of the weights (100 parts by weight) of the crosslinkable rubber and the PAAT. If the content of the peroxide crosslinking agent is lower than the lower limit, the degree of crosslinking tends to be insufficient. Meanwhile, if the content of the peroxide crosslinking agent exceeds the upper limit, excessive crosslinking may occur, with the result that the elongation is lowered, the function of the foam is lost, and the cost-effectiveness is disadvantageous.

The biodegradable foam composition essentially includes any suitable foaming agent (also known as a pore forming agent or expanding agent) known in the art. Examples of such foaming agents include gaseous materials, volatile liquids, and chemical agents that are decomposed into gases and other byproducts. When blended with the biodegradable foam composition, the foaming agent generates a gas under predetermined temperature, pressure, and time conditions to form a cell foam. The formation of the foam can achieve light weight, good cushioning feeling, and cost reduction.

Examples of suitable foaming agents include physical foaming agents and chemical foaming agents, which may be used alone or in combination. Physical foaming agents (PBAs) undergo a phase change, such as liquid volatilization or gas decomposition, to form cells. Physical foaming agents are non-toxic, odorless, thermally stable, and inexpensive and leave no solid residue. Despite these advantages, the use of physical foaming agents requires expensive equipment.

Examples of useful physical foaming agents include inorganic foaming agents and organic foaming agents. Examples of suitable physical foaming agents include carbon dioxide, nitrogen, argon, water, air, and helium. Examples of suitable organic foaming agents include C₁-C₉ aliphatic hydrocarbons, C₁-C₃ aliphatic alcohols, and C₁-C₄ halogenated aliphatic hydrocarbons.

The aliphatic hydrocarbons include methane, ethane, propane, n-butane, isobutane, n-pentane, isopentane, and neopentane.

The aliphatic alcohols include methanol, ethanol, n-propanol, and isopropanol.

The halogenated aliphatic hydrocarbons include fluorocarbons, chlorocarbons, and chlorofluorocarbons. Specific examples of fluorocarbons include methyl fluoride, perfluoromethane, ethyl fluoride, 1,1-difluoroethane (HFC-152a), 1,1,1-trifluoroethane (HFC-143a), 1,1,1,2-tetrafluoroethane (HFC-134a), 1,1,2,2-tetrafluoromethane (HFC-134), pentafluoroethane, difluoromethane, perfluoroethane, 2,2-difluoropropane, 1,1,1-trifluoropropane, perfluoropropane, dichloropropane, difluoropropane, perfluorobutane, and perfluorocyclobutane.

The halogenated aliphatic hydrocarbons may be partially halogenated ones. Specific examples of such partially halogenated aliphatic hydrocarbons include methyl chloride, methylene chloride, ethyl chloride, 1,1,1-trichloroethane, 1,1-dichloro-1-fluoroethane (HCFC-141b), 1-chloro-1,1-difluoroethane (HCFC-142b), chlorodifluoromethane (HCFC-22), 1,1-dichloro-2,2,2-trifluoroethane (HCFC-123), and 1-chloro-1,2,2,2-tetrafluoroethane (HCFC-124). The halogenated aliphatic hydrocarbons may be fully halogenated ones. Specific examples of such fully halogenated aliphatic hydrocarbons include trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane.

Chemical foaming agents (CBAs) undergo thermal decomposition or chemical reactions (for example, component reactions) to generate gases, leaving cells. Such gases are mostly N₂ and CO₂ and they behave like physical foaming agents but leave residues after decomposition. Chemical foaming agents are classified into exothermic CBAs and endothermic CBAs. Exothermic CBAs release heat and produce mainly N₂ during their decomposition whereas endothermic CBAs absorbs heat and usually generate CO₂ during their decomposition.

It is important to choose a suitable chemical foaming agent for foaming the biodegradable foam composition. The first important consideration in choosing a suitable chemical foaming agent is the decomposition temperature of the chemical foaming agent. A chemical foaming agent having a very high decomposition temperature lowers the melt strength of a polymer at the foaming temperature, and as a result, the polymer is not strong enough to maintain its bubble structure or prevent cell aggregation. Meanwhile, a chemical foaming agent having a very low decomposition temperature stiffens a polymer melt to suppress foam expansion. Another problem is that CBA decomposition residues and gases are compatible with polymers and processing systems.

Examples of the chemical foaming agents include, but are not limited to, azodicarbonamide (ADCA), azodiisobutyronitrile, benzenesulfonhydrazide, 4,4-oxybenzene sulfonyl-semicarbazide, p-toluene sulfonyl semicarbazide, barium azodicarboxylate, N,N′-dimethyl-N,N′-dinitrosoterephthalamide, dinitrosopentamethylenetetramine (DPT), p,p′-oxybisbenzenesulfonylhydrazide (OBSH), and trihydrazinotriazine.

The foaming agent is preferably an azo-based compound having a decomposition temperature of 130 to 210° C. The azo-based compound is typically azodicarbonamide (ADCA). ADCA is the most commonly used foaming agent because it rapidly generates a large amount of gas when thermally decomposed and has self-extinguishing properties and non-toxicity. The decomposition temperature of the foaming agent is appropriately from 130 to 170° C. taking into account the subsequent processing of products using the biodegradable foam composition and the specific gravity of the foamed foam composition.

A kicker may be optionally used to lower the foaming temperature of the chemical foaming agent to activate the foaming agent. Suitable kickers may polyols, ureas, amines, minerals, and metal compounds, such as lead, zinc, and cadmium compounds. Generally, a pigment or filler can perform the same role as the kicker.

The foaming agent may be a physical foaming agent. In this case, the foaming agent is preferably used in an amount of 0.1 to 10 parts by weight, based on the sum of the weights (100 parts by weight) of the crosslinkable rubber and the PAAT. Alternatively, the foaming agent may be a chemical foaming agent. In this case, the foaming agent is preferably used in an amount of 0.1 to 6 parts by weight, based on the sum of the weights (100 parts by weight) of the crosslinkable rubber and the PAAT. If the amount of the foaming agent used is less than the lower limit defined above, the specific gravity may increase and the hardness may be excessively high. Meanwhile, if the amount of the foaming agent used exceeds the upper limit defined above, the specific gravity may decrease, resulting in low strength of a product manufactured using the biodegradable foam composition. If the decomposition temperature is lower than 150° C., premature foaming occurs during preparation of the biodegradable foam composition. If the decomposition temperature exceeds 210° C., the foaming agent is difficult to decompose in an extruder. When a cylinder of an extruder is heated to decompose the foaming agent, the high temperature of the biodegradable foam composition escaping from a die causes leakage of the foaming gas, making it difficult to form a foam.

The biodegradable foam composition may further include a compatibilizer. The compatibilizer can increase the miscibility between the rubber component and the PAAT component to improve the physical properties of the biodegradable foam composition. Preferably, the compatibilizer is a maleic anhydride (MAH)-grafted rubber. The maleic anhydride grafting can improve the mechanical properties of the biodegradable foam composition. The grafting rate with maleic anhydride may be in the range of 1 to 10 parts by weight, based on 100 parts by weight of the crosslinkable polymer. This range ensures the performance of the compatibilizer.

The rubber component of the maleic anhydride-grafted rubber may be, for example, EPM, EPDM or silicone rubber that has an extremely low compatibility with the PAAT.

According to one embodiment of the present invention, the biodegradable foam composition may further include a filler. The filler may be an inorganic or organic filler. Examples of inorganic fillers suitable for use in the present invention include talc, calcium carbonate, zinc carbonate, wollastonite, silica, alumina, magnesium oxide, calcium silicate, sodium aluminate, calcium aluminate, sodium aluminosilicate, magnesium silicate, glass balloons, carbon black, zinc oxide, antimony trioxide, zeolite, hydrotalcite, metal fibers, metal whiskers, ceramic whiskers, potassium titanate, boron nitride, graphite, glass fibers, and carbon fibers. Examples of organic fillers suitable for use in the present invention include naturally occurring polymers such as starch, cellulose microparticles, wood flour, soybean mash, rice husk, wheat bran, and modified products thereof. For higher performance, the filler may be used in admixture with one or more other fillers with different sizes or physical properties. The combined use of the fillers leads to a reduction in porosity to create new physical properties. The physical properties of the fillers can also be imparted to the foam.

The filler may be present in an amount of less than 30 parts by weight, for example, 5 to 30 parts by weight, based on the sum of the weights (100 parts by weight) of the crosslinkable polymer and the PAAT. If the filler is present in an amount of less than 5 parts by weight, the effects (for example, elasticity and strength improvements) provided by the filler may be difficult to expect. Meanwhile, if the filler is present in an amount exceeding 30 parts by weight, the relatively increased proportion of the filler may lead to poor durability or cause poor physical properties of the PAAT.

The composition may further include an antioxidant, if needed. The antioxidant may be present in an amount of 0.1 to 5% by weight, preferably 1.0 to 5% by weight, based on the total weight of the composition. If the amount of the antioxidant is less than the lower limit, sufficient antioxidant activity of the product cannot be expected. Meanwhile, if the amount of the antioxidant exceeds the upper limit, the physical properties of the product may deteriorate. Thus, it is preferable to limit the amount of the antioxidant to the range of 0.1 to 5% by weight.

The biodegradable foam composition can be molded into various products. For example, the biodegradable foam composition may be mixed in a mixer such as a Banbury mixer, kneader or open mill, processed into a sheet in an open mill, and molded by compression molding. After the composition is injected into a mold having the shape of a product (for example, a shoe sole or chair seat), it is allowed to foam and expand according to the shape of the mold to form a foam having the desired shape.

According to one embodiment of the present invention, the biodegradable foam composition may be compounded with one or more other biodegradable plastics, including poly(butylene succinate-co-adipate) (PBSA) and a polyalkylene isosorbide adipate-co-terephthalate (PAIAT), to control its physical properties. The compounded composition can be processed into a more eco-friendly product of great utility.

The presence of the crosslinkable rubber and the PAAT (e.g., PBAT) makes the biodegradable foam composition of the present invention highly processable and allows a molded product manufactured from the biodegradable foam composition to be highly biodegradable and have high strength and durability.

The biodegradable foam composition of the present invention has a Shore C hardness of 40 to 80, preferably 45 to 70, a tensile strength of at least 15 kg/cm², preferably 20 to 30 kg/cm², an elongation of at least 200%, preferably 250 to 300%, a tear strength of at least 8 kg/cm, preferably 10 to 20 kg/cm, a rebound resilience of at least 40%, preferably 40 to 55%, and a wear resistance (DIN) of 250 or less, preferably 200 or less. Within these ranges, the foam composition of the present invention can be used to manufacture a foam with appropriate elasticity. Meanwhile, outside these ranges, the foam composition of the present invention may not exhibit foam properties or have poor durability, making its use difficult.

The biodegradable foam composition of the present invention may have a biodegradation rate of at least 35% by weight, preferably at least 50% by weight, after 6 months, as measured according to the ISO 14855 standard. Since any test method is not specified for biodegradable foams, the biodegradability of the biodegradable foam composition according to the present invention is measured according to the ISO 14855 standard, which is a test method for the biodegradability of plastics. The biodegradable foam composition of the present invention has a biodegradation rate of at least 35% by weight. If the biodegradation rate of the biodegradable foam composition is lower than 35% by weight, the biodegradable foam composition may not be biodegradable even after a long period of time due to its poor biodegradability.

Preferred embodiments of the present invention will be described in detail with reference to the accompanying drawings such that those skilled in the art can readily practice the invention. In describing the present invention, detailed explanations of a related known function or construction are omitted when it is deemed that they may unnecessarily obscure the essence of the invention. Certain features shown in the drawings are enlarged, reduced or simplified for ease of illustration and the drawings and the elements thereof are not necessarily in proper proportion. However, those skilled in the art will readily understand such details.

### EXAMPLES

Biodegradable foam compositions were prepared using the following raw materials:
Rubber-1: SBR 1502 (Kumho Petrochemical)
Rubber-2: BR 01 (Kumho Petrochemical)
Rubber-3: SBS 3527 (LCY)
Rubber-4: EPDM 4520 (DOW)
Rubber-5: Butyl 268 (isobutylene isoprene rubber, Exxon)
PBAT: Solpol 1000 (Solchemical)
Compatibilizer: KEPA 1150 (MAH grafted EPDM, Kumho Polychem)
Peroxide: Luperox F (di-(2-t-butylperoxyisopropyl)benzene, ARKEMA)
Foaming agent: DX74M (Modified ADCA, decomposition temperature 140° C., amount of gas generated 155 cc/g, DONGJIN SEMICHEM)

The rubbers, PBAT, and compatibilizer were weighed as shown in Tables 1 and 2, put in a kneader, and mixed at 100° C. for 10 min. To each of the mixtures were added the peroxide crosslinking agent and the foaming agents, followed by mixing for 2 min. The resulting mixture was taken out of the kneader, processed into a 5 mm thick sheet in an open mill, and placed in a 10 mm thick specimen mold. The specimen mold was subjected to compression molding at 185° C. for 5 min, followed by exposure to the outside and foaming to obtain a 16 mm thick specimen.

The figures given in Tables 1 and 2 represent parts by weight of the raw materials unless otherwise mentioned.

TABLE 1

| | | | | | Comp. | |
|---|---|---|---|---|---|---|
| | Example 1 | Example 2 | Example 3 | Example 4 | Example 1 | Example 5 |
| Rubber-1 | 40 | — | — | — | — | — |
| Rubber-2 | — | 40 | — | — | — | — |
| Rubber-3 | — | — | 40 | — | — | — |
| Rubber-4 | — | — | — | 40 | — | 40 |
| Rubber-5 | — | — | — | — | 40 | — |
| PBAT | 60 | 60 | 60 | 60 | 60 | 60 |
| Compatibilizer | — | — | — | — | — | 5.0 |
| Peroxide | 0.7 | 0.5 | 0.7 | 1.0 | 2.0 | 1.0 |
| Foaming agent | 3 | 3 | 3 | 3 | 3 | 3 |
| Filler | — | — | — | — | — | — |

TABLE 2

| | | Comp. | | | Comp. | Comp. | Comp. |
|---|---|---|---|---|---|---|---|
| | Example 6 | Example 2 | Example 7 | Example 8 | Example 3 | Example 4 | Example 5 |
| Rubber-1 | 30 | 20 | 50 | 60 | 65 | | |
| Rubber-2 | — | — | — | — | — | — | — |
| Rubber-3 | — | — | — | — | — | 65 | 65 |
| Rubber-4 | — | — | — | — | — | — | — |
| Rubber-5 | — | — | — | — | — | — | — |
| PBAT | 70 | 80 | 50 | 40 | 35 | 35 | 35 |
| Compatibilizer | — | — | — | — | — | — | — |
| Peroxide | 0.8 | 0.9 | 0.6 | 0.5 | 0.5 | 0.5 | 0.5 |
| Foaming agent | 3 | 3 | 3 | 3 | 3 | 3 | 4 |

The specimen was measured for workability, shrinkage after work, specific gravity (g/cc), hardness (Shore C), and tensile strength (kg/cm²), which are generally used to determine the physical properties of molded foams. Based on these results, the applicability of the molded foam was determined.

Tensile strength: After the molded foam composition was skived to a thickness of 3.0 mm, its tensile strength was measured by the ASTM D-412 testing method. The molded foam composition was evaluated to be suitable for a molded foam when its tensile strength was >20 kg/cm².

TABLE 3

| | | Specific | | Tensile | Applicability |
|---|---|---|---|---|---|
| | Shrinkage | gravity | Hardness | strength | (Y/N) |
| Example 1 | Good | 0.20 | 55 | 22 | Y |
| Example 2 | Good | 0.20 | 56 | 22 | Y |
| Example 3 | Good | 0.20 | 60 | 23 | Y |
| Example 4 | Good | 0.18 | 54 | 18 | Y |
| Comparative | Bad | Non- | — | — | N |
| Example 1 | | foamable | | | |
| Example 5 | Good | 0.18 | 54 | 22 | Y |
| Example 6 | Good | 0.22 | 70 | 28 | Y |
| Comparative | Good | 0.25 | 85 | 33 | N |
| Example 2 | | | | | |
| Example 7 | Good | 0.18 | 45 | 19 | Y |
| Example 8 | Good | 0.16 | 40 | 18 | Y |
| Comparative | Bad | 0.15 | 33 | 15 | N |
| Example 3 | | | | | |
| Comparative | Good | 0.15 | 45 | 19 | Y |
| Example 4 | | | | | |
| Comparative | Good | 0.13 | 35 | 15 | N |
| Example 5 | | | | | |

From the results in Table 3, the foam compositions of Examples 1-8 were found to be suitable for molded foams.

An experiment was conducted to determine the biodegradability of the foam. Since there is no test method for biodegradable foams, the test was conducted according to the ISO 14855 standard, which is a test method for biodegradable plastics.

The biodegradability of the specimen after 6 months was measured according to the ISO 14855 standard. Since biodegradable foams have not existed until now, there is no standard for biodegradable foams. According to the ISO 14855 standard, a biodegradable plastic is certified to be biodegradable when at least 60% by weight of the biodegradable plastic for 45 days or at least 90% by weight of the biodegradable plastic for 6 months is biodegraded. Here, the biodegradation rate of 90% by weight means that 90% by weight of the plastic is converted to carbon dioxide for 6 months.

TABLE 4

| | | Suitability for |
|---|---|---|
| | Biodegradability (%) | biodegradable foam |
| Example 1 | 55 | Suitable |
| Example 2 | 55 | Suitable |
| Example 3 | 55 | Suitable |
| Example 4 | 55 | Suitable |
| Comparative | — | Unsuitable |
| Example 1 | | |
| Example 5 | 53 | Suitable |
| Example 6 | 64 | Suitable |
| Comparative | 73 | Suitable |
| Example 2 | | |
| Example 7 | 46 | Suitable |
| Example 8 | 37 | Suitable |
| Comparative | 32 | Unsuitable |
| Example 3 | | |
| Comparative | 32 | Unsuitable |
| Example 4 | | |
| Comparative | 32 | Unsuitable |
| Example 5 | | |

The inventive biodegradable foam does not biodegrade as much as biodegradable plastics, but 50% by weight of the inventive biodegradable foam degrades in the ground and evaporates into carbon dioxide and the remaining portion (50% by weight) of the inventive biodegradable foam is broken down into molecules and exists in the soil. A portion of the inventive biodegradable foam remains undegraded but the soil almost restores its function. Therefore, the inventive biodegradable foam is of sufficient value.

The results in Table 4 demonstrate that the foam compositions of Examples 1-8 are suitable for use in biodegradable foams. The foam compositions of Comparative Examples 2-5 were found to be biodegradable. However, as shown in Table 3, the physical properties of the foam compositions of Comparative Examples 1-5 make it impossible to apply the foam compositions to foams, leading to the conclusion that the foam compositions of Comparative Examples 1-5 cannot be used in biodegradable foams.

Although the particulars of the present invention have been described in detail, it will be obvious to those skilled in the art that such particulars are merely preferred embodiments and are not intended to limit the scope of the present invention. Therefore, the true scope of the present invention is defined by the appended claims and their equivalents.

1. A biodegradable foam composition comprising a polyalkylene adipate terephthalate (PAAT) resin, a peroxide crosslinking agent, a polymer capable of being crosslinked by the peroxide crosslinking agent, and a foaming agent.

2. The biodegradable foam composition according to claim 1, wherein the polyalkylene adipate terephthalate (PAAT) resin is a polyethylene adipate terephthalate, polybutylene adipate terephthalate or polytrimethylene adipate terephthalate resin.

3. The biodegradable foam composition according to claim 1, wherein the crosslinkable polymer is a crosslinkable plastic or rubber.

4. The biodegradable foam composition according to claim 3, wherein the crosslinkable plastic is an ethylene homopolymer or copolymer.

5. The biodegradable foam composition according to claim 3, wherein the crosslinkable rubber is selected from the group consisting of natural rubber (NR), styrene butadiene rubber (SBR), butadiene rubber (BR), styrene butadiene styrene (SBS) rubber, nitrile-butadiene rubber (NBR), ethylene-propylene rubber (EPM), ethylene-propylene diene monomer (EPDM) rubber, silicone rubber, styrene block copolymer (SBC), 1,2-polybutadiene (1,2-PB), chlorinated polyethylene (CPE), ethylene vinyl acetate rubber (EVM), thermoplastic polyurethane (TPU) elastomer, and mixtures thereof.

6. The biodegradable foam composition according to claim 1, wherein the polyalkylene adipate terephthalate resin and the crosslinkable polymer are present in a weight ratio of 95:5 to 30:70.

7. The biodegradable foam composition according to claim 1, further comprising a compatibilizer.

8. The biodegradable foam composition according to claim 7, wherein the compatibilizer is a maleic anhydride (MAH)-grafted rubber.

9. The biodegradable foam composition according to claim 1, wherein the peroxide crosslinking agent is selected from the group consisting of t-butyl peroxyisopropyl carbonate, t-butyl peroxylaurylate, t-butyl peroxyacetate, di-t-butyl peroxyphthalate, t-dibutyl peroxymaleate, cyclohexanone peroxide, t-butyl cumyl peroxide, t-butyl hydroperoxide, t-butyl peroxybenzoate, dicumyl peroxide, 1,3-bis(t-butylperoxyisopropyl)benzene, methyl ethyl ketone peroxide, 2,5-dimethyl-2,5-di(benzoyloxy)hexane, 2,5-dimethyl-2,5-di(t-butylperoxy)hexane, di-t-butyl peroxide, 2,5-dimethyl-2,5-(t-butylperoxy)-3-hexane, n-butyl-4,4-bis(t-butylperoxy)valerate, α,α′-bis(t-butylperoxy)diisopropylbenzene, and mixtures thereof.

10. The biodegradable foam composition according to claim 1, wherein the foaming agent is a physical or chemical foaming agent.
